(19) United States
(12) Patent Application Publication
(10) Pub. No.: US 2025/0061443 A1
(43) Pub. Date: Feb. 20, 2025

(54) APPARATUS. SYSTEM. AND METHOD OF PROVIDING ACCESS TO, PURCHASE OF, AND DISPLAY OF NON-FUNGIBLE TOKENS

(71) Applicants: Josh Lehman, Las Vegas, NV (US); Sean McCue, Las Vegas, NV (US)

(72) Inventors: Josh Lehman, Las Vegas, NV (US); Sean McCue, Las Vegas, NV (US)

(21) Appl. No.: 18/800,256

(22) Filed: Aug. 12, 2024

Related U.S. Application Data
(60) Provisional application No. 63/520,453, filed on Aug. 18, 2023.

(51) Int. Cl. G06Q 20/36; G06F 16/45; G06Q 30/0201

(52) U.S. Cl. CPC G06Q 20/3674; G06F 16/45; G06Q 30/0206

(57) ABSTRACT

An apparatus, system and method for a NFT wallet application (app). The NFT wallet app includes: an accumulator of non-fungible tokens (NFT); a categorizer for categorizing the NFTs according to information in the NFTs; an appender for appending to the NFTs owner information related to an owner of the NFTs; a valuator for valuing the NFTs, wherein the valuator accesses anonymized data regarding values of other NFTs not owned by the owner; and a display interface for interfacing to a dedicated display for ones of the NFTs.

### CROSS-REFERENCE TO RELATED APPLICATIONS

This application claims priority to U.S. Provisional Application No. 63/520,453 filed on Aug. 18, 2023, incorporated herein by reference in its entirety.

### BACKGROUND

### Field of the Disclosure

The disclosure relates generally to non-fungible tokens, and, more particularly, to an apparatus, system, and method of providing access to a purchase of non-fungible tokens.

### Background of the Disclosure

As used herein, the definition of a non-fungible token (NFT) is a cryptographic asset on a blockchain with unique identification codes and metadata that distinguish it from other assets on the blockchain. That is, an NFT is an asset that has been tokenized for the blockchain, by which it has been assigned a unique identification code and unique associated metadata to distinguish it from other tokens.

As will be understood, NFTs can be traded or otherwise exchanged, such as for money, cryptocurrency, or on their other NFTs. As such, NFTs have a value dependent on the market of what other parties will pay for the NFT.

By way of example, cryptocurrency is also comprised of a token. However, a key difference between cryptocurrency and an NFT is that two cryptocurrencies from the same blockchain are interchangeable; consequently, they are fungible. However, two NFTs from the same blockchain may be similar, but are not interchangeable, therefore they are non-fungible.

As indicated, tokenizing assets, including otherwise tangible assets, allows for the buying, selling, and trading of these tokenized assets more efficiently, while also presenting a lower probability of fraud. NFTs may represent identities, properties, property rights, artistic expressions, and so on.

NFTs are typically built by following the ERC-721 (Ethereum Request for Comment #721), which dictates how ownership is transferred, methods for confirmation of transactions, and how applications handle NFT transfers. Of course, it will be appreciated that different standards may be used.

NFTs may be created through a process called minting, in which the information of the NFT is recorded on a blockchain. The minting process thus entails that a new block is created on the blockchain, that the NFT information of that block is validated by the blockchain validator, and that the block is closed to modification (but not appending) upon creation.

Digital wallets, or simply “wallet apps”, are well understood in the pertinent arts. For example, Apple wallet is included in the iOS, and allows users to store “passes”, such as coupons, tickets, boarding passes, identification cards, business credentials, entry passes, car keys, home keys, transportation passes, credit cards, debit cards, and other payment methods, by way of non-limiting example.

In a typical embodiment, a wallet “pass” includes a unique identifier that allows for use of the pass in the wallet only in the manner for which such use is authorized. For example, wallet passes may include barcodes, QR codes, near field communication codes, or other identifying information that allows the use of the pass for the purpose for which the pass is authorized.

### SUMMARY OF THE DISCLOSURE

The embodiments include an NFT wallet application (app) executed by a computing processor. The NFT wallet app includes: an accumulator of non-fungible tokens (NFTs); a categorizer for categorizing the NFTs according to information in the NFTs; an appender for appending to the NFTs owner information related to an owner of the NFTs; a valuator for valuing the NFTs, wherein the valuator accesses anonymized data regarding values of other NFTs not owned by the owner; and a display interface for interfacing to a dedicated display for ones of the NFTs. Every time the wallet app is opened, a user may be verified through a smart contract before the user's NFTs, digital collectibles, or digital assets are displayed or utilized.

The embodiments include configuring the app to group an arrangement or collection of NFTs, such as groupings that correspond to an animation, video, a sound, a song, an audio recording or sample, and any combinations thereof.

The embodiments include configuring the app to categorize and/or valuate the NFTs, and determine market supply and demand thereof.

The embodiments include an owner authenticator for accessing the application. The owner authenticator uses a key such as biometric key, a pass key, and a multi-factor key.

### BRIEF DESCRIPTION OF THE DRAWINGS

The disclosure is illustrated by way of example and not limitation in the accompanying drawings, in which like references may indicate similar elements, and in which:

FIG. 1 is an illustration of aspects of the embodiments;

FIG. 2 is an illustration of aspects of the embodiments;

FIG. 3 is an illustration of aspects of the embodiments;

FIG. 4 is an illustration of aspects of the embodiments;

FIG. 5 is an illustration of aspects of the embodiments;

FIG. 6 illustrate aspects of the embodiments; and

FIG. 7 is an illustration of a computing device.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Processor-implemented modules, systems and methods of use are disclosed herein that may provide access to and transformation of a plurality of types of digital content, including but not limited to video, image, text, audio, metadata, algorithms, interactive and document content, and which track, deliver, manipulate, transform, transceive and report the accessed content. Described embodiments of these modules, systems and methods are intended to be exemplary and not limiting. As such, it is contemplated that the herein described systems and methods may be adapted and may be extended to provide enhancements and/or additions to the exemplary modules, systems and methods described. The disclosure is thus intended to include all such extensions.

In the embodiments of the disclosure, a “wallet” may be provided for the storage and use of NFTs. Correspondingly, the NFT wallet may include NFT assets, and may also include access to applications necessary for the use of the NFTs in the wallet as intended. That is, for example, streaming or photo apps may be actuated upon accessing a photo or video NFT in the NFT wallet. Likewise, a smart TV app may be used to stream a TV NFT from the wallet upon accessing of that NFT in the wallet. Similarly, the NFT wallet may include a dedicated NFT display app, such as in which any NFT in any format from any location may be genericized for actuation and display from the dedicated NFT wallet display app. Needless to say, such a dedicated app may be phone or computer controlled, based upon whatever computer processor unit the NFT wallet is associated with.

Simply put, the disclosed NFT wallet may pull any and all blockchain data from any application on a device with which the NFT wallet is associated, such as with a mobile device, and may combine all such NFT values from any location. These NFT values may then be made serially available, such as in a list by acquisition date, a list by NFT type, or so on in the NFT wallet app, or may be categorized (i.e., “entertainment”, “collectibles”, etc.) within the NFT wallet app for ease of location by a user. For example, as the NFT block necessarily includes information associated with what the NFT block constitutes, the NFT wallet app may read such information and take therefrom a category in which the NFT is to be listed in the NFT wallet app.

The NFT wallet may make available previously unknown NFTs for sale and purchase. For example, at a retail location, animation cells or video snippets may be sold as NFTs. Correspondingly, the creator of the cells or the video may still be the owner thereof, but the purchaser of the NFT may be purchasing a license, such as the display rights, for that NFT through his or her NFT wallet app. In such a case, the animation sells may be individually displayed, or may be consecutively displayed as a movie snippet, for example. In this case, the purchase of the cells I snippet may be made available separately or together. That is, the animation cells may be individually purchased or separately may be purchased as a snippet of video, or a certain number of cells may be purchased as individual cells and a movie snippet to the same purchaser.

By way of example, 1,800 NFTs may be used as individual cells to make up a grouping (e.g., a 5-minute video clip). The purchaser may purchase these 1800 NFTs either for display or resale of display rights as individual cells/frames, and/or may be able to use or resell all 1,800 frames together as a video clip. Thus, a single NFT could be each individual cell, or a token may be a 5-minute scene, or both.

Thereby, the grouping (e.g., snippet of video) may have a commoditized value, such as on a per frame, per snip, or a per full clip basis. This commoditized value allows for resale or use by the user in a manner not known in the current art.

For example, blockbuster movies often have scenes cut from those movies. These cut scenes could be sold as NFTs in the current embodiment, either on a per frame basis, a partial scene basis, or a per full scene basis. Thus, a purchaser of the NFT of the cut scene may, in essence, receive a private screening of the movie's cut scene, and may have the right to resell that ability for private screening.

Moreover, the disclosed NFT Wallet app may not be limited to use on a personal computer or a mobile device. For example, a dedicated NFT display may be available that is controlled by the personal computer or the mobile device on which the NFT wallet app and NFT wallet player are located.

The dedicated NFT display disclosed herein may thus have communication capabilities to communicate with an authorized NFT Wallet app. This communication may, of course, include typical handshaking between a mobile device and a separate display device. Such handshaking may occur via wi-fi, bluetooth, nfc, or via other known communication methodologies, and may or may not include login to the dedicated display by a user, entry of a code on the dedicated display or the communicating mobile device, or the like.

In additional examples of secondary device access to the NFT wallet app, the NFT itself may have associated therewith access information upon purchase by a user. That is, the NFT may have associated with it access information correspondent to its current owner, appended onto the NFT block. Thus, an owner may be able to access the NFT via his or her phone through the NFT wallet app by a facial or like biometric scan, a fingerprint, a login, or the like. As such, the user I owner may be able to track all NFTs he or she owns, and may make use of the NFT wallet app and display app remotely, via permissions through the NFT wallet app, or through the NFTs themselves, by way of example.

In light of the above, a user may have categorically available to him or her all NFTs owned or licensed by that user. This may allow for complete real-time data on all NFTs owned, and the value or demand for the NFTs may be tracked over time and in real time. This may occur including the value of similar NFTs purchased, which may be anonymized and made known to the NFT wallet app. This allows for the use and value tracking of categorical NFTs in a manner similar to a stock, for example. Further, anonymized market data may be made available not only for individual NFTs, or categories of NFTs, or types of NFTs, but also for a wallet of NFTs in total. Thus, as is typically the case with assets, a user may be able to track an overall value of his or her NFT wallet assets in real time.

In light of the disclosure, through the use of the NFT wallet, all NFTs may have their own viewer system, their own appraisal system, and thus can be bought or sold anywhere. Needless to say, purchasing of NFTs may thus be greatly simplified, as simply taking a photo of or touching to an NFC tag or a QR code could allow for the purchase of the NFT associated with that asset. Further, as discussed above, the combination of all NFTs in a single wallet allows for a wealth of data regarding NFTs in general, as well as significant financial information for an owner of all NFTs owned by that owner.

Moreover, the disclosure allows for the movement of significant features of the internet into the blockchain in a manner not known at present. For example, when a face and finger is used to unlock an iphone, a user may go anywhere on the internet that is associated with that user, and access that user's private information, without logging in, such as through the use of the disclosed NFT wallet. That is, because the NFT wallet includes NFT information associated strictly with the user, access by the NFT wallet to internet locations and assets can be uniquely made by that user from, through, or using information from that user's NFT wallet.

In this case, hackers cannot steal information, because the information is only accessible to the user because only the user has the blockchain token or tokens that are necessary to speak to the internet location or to access the internet asset. In short, no data is being passed over the internet, rather only blockchain data and tokens are used. That is, the encrypted blockchain is the key to all internet locations and all internet assets, rather than the “login” that has been used to date. Needless to say, in prior art embodiments this login information is dangerously passed over the internet, and is thus available to hackers.

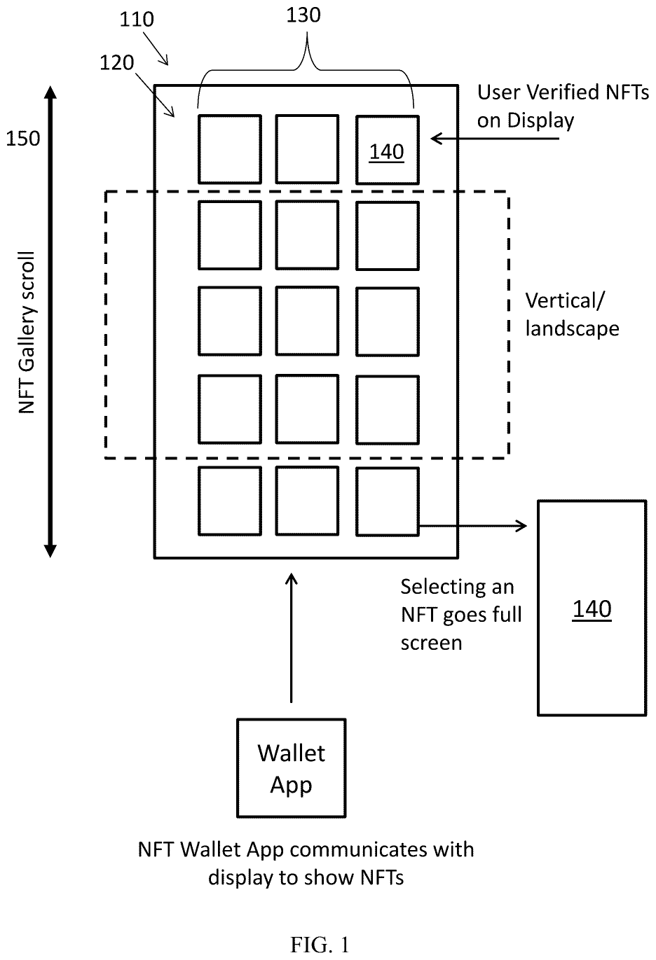

FIG. 1 illustrates a display 110 (also referred to herein as a monitor, TV, or display 1460) for viewing the user interface (UI) 120 of the disclosed wallet application. In some embodiments, the UI 120 of the wallet application shows or displays at least one NFT gallery 130 comprising one or more NFTs 140. The one or more NFTs 140 may comprise user verified NFTs, a category of NFTs, a grouping of NFTs, a serial list of NFTs, a video of NFTs, an animation of NFTS, a snippet of NFTs, NFTs owned by the owner, NFTs not owned by the owner, a marketplace of NFTS, and any combinations thereof. In some embodiments, selecting one or more of the one or more NFTs 140 enlarges the one or more NFTs 140, and/or displays the one or more NFTS 140 in full screen mode. In some embodiments, selecting one or more of the one or more NFTs 140 starts or plays a video or animation. It should be appreciated that any known UI feature or graphical user interface (GUI) feature may also be applied to the disclosed UI 120, including, but not limited to, scrolls, sliders, drop down menus, selection tools, filtering tools, display settings, user/owner settings, and the like. In some embodiments, the UI 120 and/or at least one NFT gallery 130 comprises a scroll or slider 150 for scrolling through the UI 120 or NFT gallery 130. In some embodiments, the UI 120 and/or NFT gallery 130 may be viewed in, and/or optimized for use in, either vertical or landscape mode (landscape orientation showed in dashed lines).

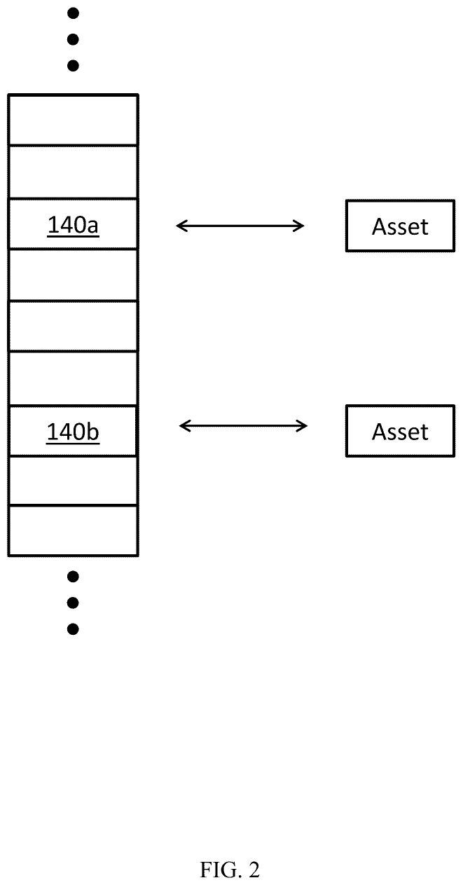

FIG. 2 illustrates an exemplary screen in the disclosed UI 120 comprising a grouping or list of one or more NFTs 140 (e.g., a first NFT 140a, and a second NFT 140b), wherein at least a portion of the one or more NFTs 140 correspond to, or are owned by the owner (i.e., an asset of the owner). For example, the list may display which NFTs are owned (first NFT 140a, second NFT 140b) by the owner, or not owned the owner in an overall grouping or list of one or more NFTs 140.

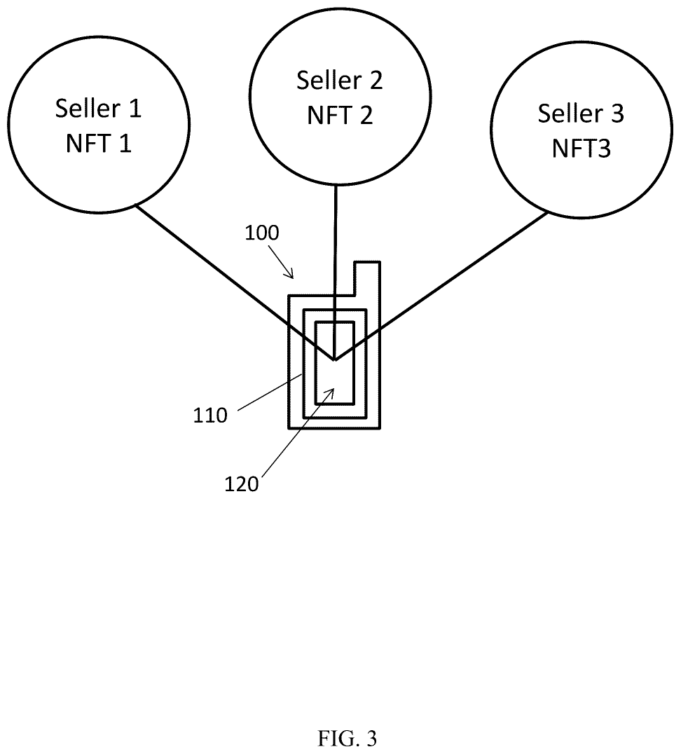

FIG. 3 illustrates a hand-held device 100 showing or displaying an exemplary screen of UI 120 on display 110, wherein the screen displays a supply or listing of one or more NFTs 140, and the corresponding sellers. This supply or listing may comprise a marketplace of one or more NFTs 140, or one or more groupings or collections of NFTs.

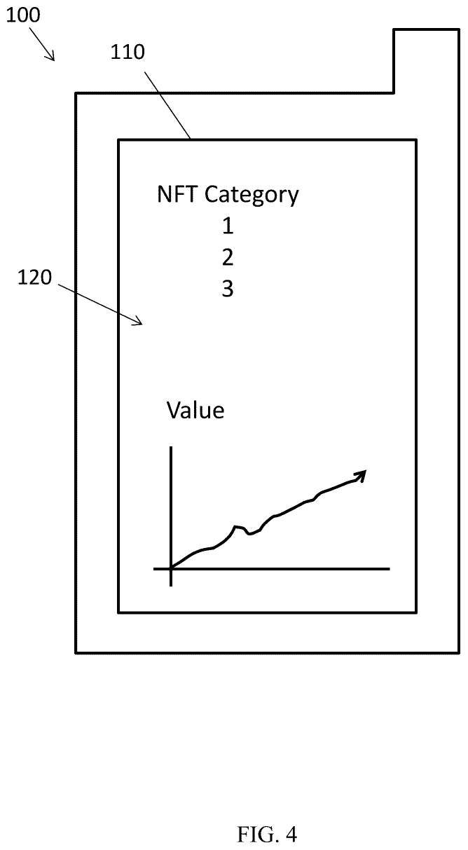

FIG. 4 illustrates a hand-held device 100 with display 110 showing an exemplary screen of UI 120, wherein the screen displays a listing of one or more NFT categories, and/or a plot displaying value of one or more NFTs 140 tracked over time.

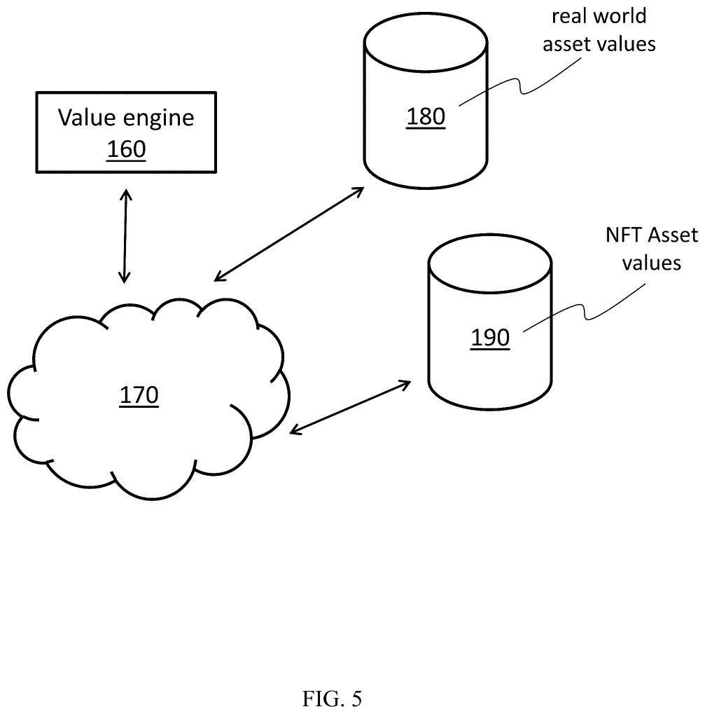

FIG. 5 illustrates aspects of the disclosed wallet application comprising a value engine 160 for valuation of NFTs that communicates with a network 170 (also referred to herein as communications network 1470) and data stores or oracles (180, 190) for real world asset values and/or NFT asset values.

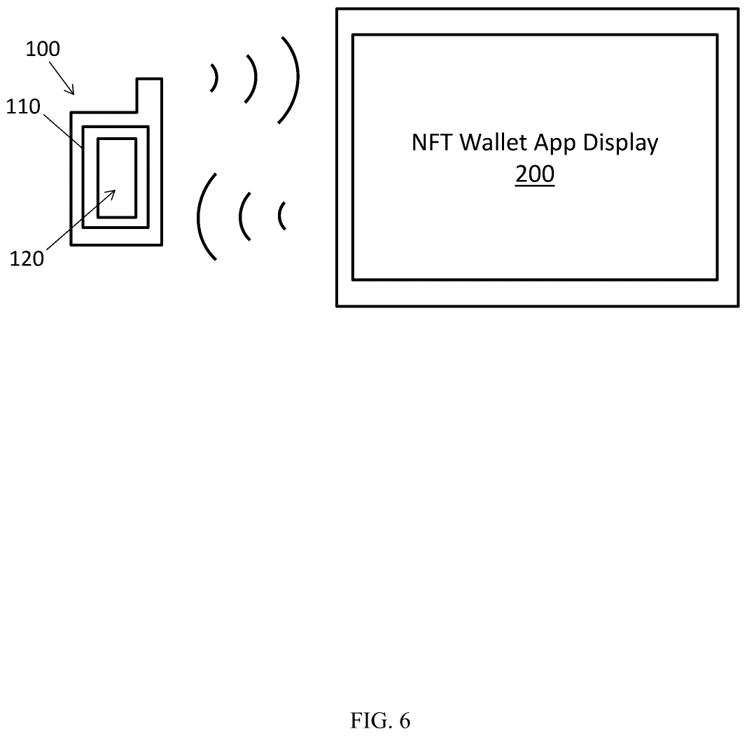

FIG. 6 illustrates the disclosed wallet application operating on a handheld-device 100 and wirelessly communicating (e.g., handshaking) with, and/or controlling one or more external displays 200 (e.g., an NFT wallet application display).

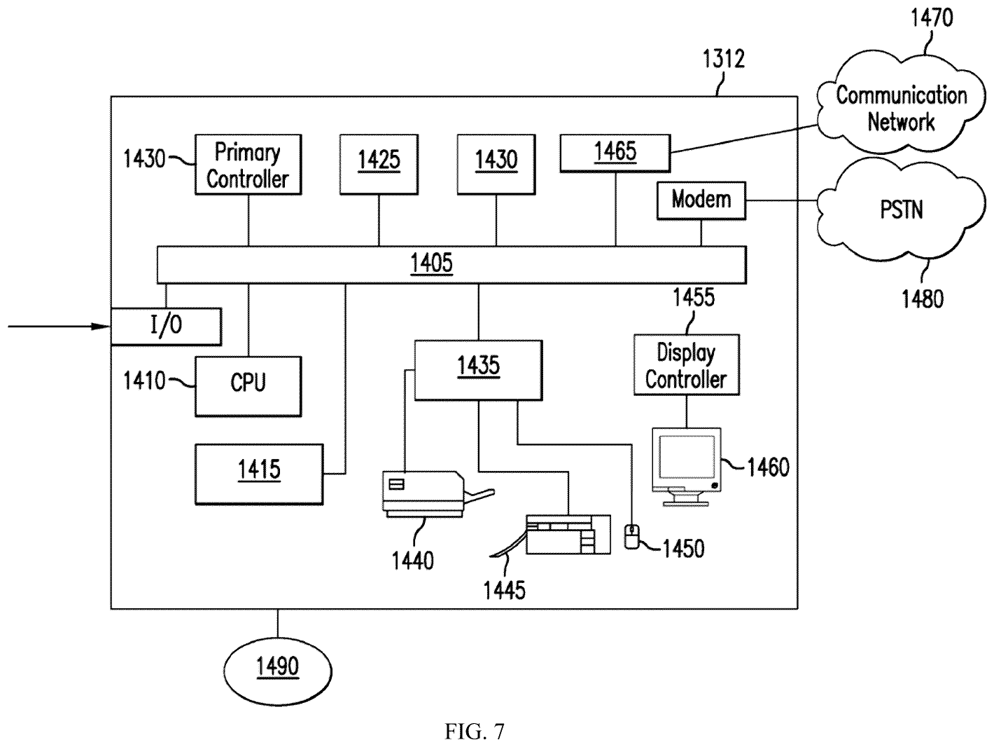

FIG. 7 depicts an exemplary computer processing system 1312 for use in association with the embodiments, by way of non-limiting example. Processing system 1312 is capable of executing software, such as an operating system (OS), applications, user interface, and/or one or more other computing algorithms/applications 1490, such as the recipes, models, programs and subprograms discussed herein. The operation of exemplary processing system 1312 is controlled primarily by these computer readable instructions/code 1490, such as instructions stored in a computer readable storage medium, such as hard disk drive (HDD) 1415, optical disk (not shown) such as a CD or DVD, solid state drive (not shown) such as a USB “thumb drive,” or the like. Such instructions may be executed within central processing unit (CPU) 1410 to cause system 1312 to perform the disclosed operations, comparisons and calculations. In many known computer servers, workstations, personal computers, and the like, CPU 1410 is implemented in an integrated circuit called a processor.

It is appreciated that, although exemplary processing system 1312 is shown to comprise a single CPU 1410, such description is merely illustrative, as processing system 1312 may comprise a plurality of CPUs 1410. Additionally, system 1312 may exploit the resources of remote CPUs (not shown) through communications network 1470 or some other data communications means 1480, as discussed throughout.

In operation, CPU 1410 fetches, decodes, and executes instructions from a computer readable storage medium, such as HDD 1415. Such instructions may be included in software 1490. Information, such as computer instructions and other computer readable data, is transferred between components of system 1312 via the system's main data-transfer path. The main data-transfer path may use a system bus architecture 1405, although other computer architectures (not shown) can be used.

Memory devices coupled to system bus 1405 may include random access memory (RAM) 1425 and/or read only memory (ROM) 1430, by way of example. Such memories include circuitry that allows information to be stored and retrieved. ROMs 1430 generally contain stored data that cannot be modified. Data stored in RAM 1425 can be read or changed by CPU 1410 or other hardware devices. Access to RAM 1425 and/or ROM 1430 may be controlled by memory controller 1420.

In addition, processing system 1312 may contain peripheral communications controller and bus 1435, which is responsible for communicating instructions from CPU 1410 to, and/or receiving data from, peripherals, such as peripherals 1440, 1445, and 1450, which may include printers, keyboards, and/or the operator interaction elements on a mobile device as discussed herein throughout. An example of a peripheral bus is the Peripheral Component Interconnect (PCI) bus that is well known in the pertinent art.

Operator display 1460, which is controlled by display controller 1455, may be used to display visual output and/or presentation data generated by or at the request of processing system 1312, such as responsive to operation of the aforementioned computing programs/applications 1490. Such visual output may include text, graphics, animated graphics, and/or video, for example. Display 1460 may be implemented with a CRT-based video display, an LCD or LED-based display, a gas plasma-based flat-panel display, a touch-panel display, or the like. Display controller 1455 includes electronic components required to generate a video signal that is sent to display 1460.

Further, processing system 1312 may contain network adapter 1465 which may be used to couple to external communication network 1470, which may include or provide access to the Internet, an intranet, an extranet, a ledger, a public ledger, a blockchain, or the like. Communications network 1470 may provide access for processing system 1312 with means of communicating and transferring software and information electronically. Additionally, communications network 1470 may provide for distributed processing, which involves several computers and the sharing of workloads or cooperative efforts in performing a task, as discussed above. Network adaptor 1465 may communicate to and from network 1470 using any available wired or wireless technologies. Such technologies may include, by way of non-limiting example, cellular, Wi-Fi, Bluetooth, infrared, or the like.

Aspects of the present invention relate to an NFT wallet application (app) executed by a computing processor. In some embodiments, the NFT wallet app comprises an accumulator of non-fungible tokens (NFTs) (e.g., one or more NFTs 140), a categorizer for categorizing the NFTs according to information in the NFTs, an appender for appending to the NFTs owner information related to an owner of the NFTs, a valuator for valuing the NFTs, wherein the valuator accesses anonymized data regarding values of other NFTs not owned by the owner, and a display interface (e.g., UI 120) for interfacing to a dedicated display (e.g., display 110) for ones of the NFTs. In some embodiments, every time the NFT wallet app is opened, a user may be verified through a smart contract before the user's NFTs, digital collectibles, or digital assets are displayed or utilized.

Aspects of the present invention relate to grouping an arrangement or collection of NFTs. In some embodiments, the categorizer groups the NFTs into one or more groupings. In some embodiments, the one or more groupings comprise NFTs arranged in an arrangement (e.g., serial arrangement, sequenced). In some embodiments, the one or more groupings correspond to an animation, video, a sound, a song, a sound sample, an audio sample, an audio recording, and any combinations thereof.

Aspects of the present invention relate to the valuation of NFTs and determining market supply and demand thereof. In some embodiments, the valuator accesses anonymized data regarding value of the one or more groupings. In some embodiments, the valuator accesses anonymized data regarding value of each NFT in the one or more groupings. In some embodiments, the valuator accesses anonymized data regarding supply or demand of the one or more groupings. In some embodiments, the valuator indexes supply or demand of the one or more groupings based on the anonymized data regarding value of the one or more groupings. In some embodiments, the supply or demand of the one or more groupings is tracked in real-time. In some embodiments, the supply or demand of the one or more groupings is tracked over time.

In some embodiments, the valuator accesses anonymized data regarding values of NFTs owned by the owner. In some embodiments, the value of NFTs owned by the owner are tracked in real-time. In some embodiments, the value of NFTs owned by the owner are tracked over time. In some embodiments, the value of the other NFTs not owned by the owner are tracked in real-time. In some embodiments, the value of the other NFTs not owned by the owner are tracked over time.

In some embodiments, the valuator accesses anonymized data regarding supply or demand of the NFTs. In some embodiments, the anonymized data regarding supply or demand of the NFTs comprises NFTs owned by the owner. In some embodiments, the anonymized data regarding supply or demand of the NFTs comprises NFTs not owned by the owner. In some embodiments, the valuator indexes supply or demand of the NFTs based on information in the NFTs.

In some embodiments, the application comprises an owner authenticator for accessing the application. In some embodiments, the owner authenticator comprises a key selected from the group consisting of a biometric key, a pass key, and a multi-factor key.

A method for grouping NFTs, comprising the steps of providing one or more samples (e.g., videos, animations, audio samples, songs, or the like), each sample separable into one or more frames, the series of the frames being representative of the entire sample, assigning one or more NFTs to each frame of the one or more frames, grouping the NFTs into one or more groupings, wherein the one or more groupings of NFTs is representative of at least a portion of the provided sample, and ownership of the NFT or grouping assigns ownership of the frame or frames to an owner.

In the foregoing Detailed Description, it can be seen that various features are grouped together in a single embodiment for the purpose of clarity and brevity of the disclosure. This method of disclosure is not to be interpreted as reflecting an intention that the embodiments require more features than are expressly recited herein. Rather, the disclosure is to encompass all variations and modifications to the disclosed embodiments that would be understood to the skilled artisan in light of the disclosure.

What is claimed is:

1. An application executed by a computing processor, comprising:
an accumulator of non-fungible tokens (NFTs);
a categorizer for categorizing the NFTs according to information in the NFTs;
an appender for appending to the NFTs owner information related to an owner of the NFTs;
a valuator for valuing the NFTs, wherein the valuator accesses anonymized data regarding values of other NFTs not owned by the owner; and
a display interface for interfacing to a dedicated display for ones of the NFTs.

2. The application of claim 1, wherein the categorizer groups the NFTs into one or more groupings.

3. The application of claim 2, wherein the one or more groupings comprise NFTs arranged to correspond to an animation, video or sound.

4. The application of claim 2, wherein the valuator accesses anonymized data regarding value of the one or more groupings.

5. The application of claim 2, wherein the valuator accesses anonymized data regarding value of each NFT in the one or more groupings.

6. The application of claim 2, wherein the valuator accesses anonymized data regarding supply or demand of the one or more groupings.

7. The application of claim 2, wherein the valuator indexes supply or demand of the one or more groupings based on the anonymized data regarding value of the one or more groupings.

8. The application of claim 2, wherein the supply or demand of the one or more groupings is tracked in real-time.

9. The application of claim 2, wherein the supply or demand of the one or more groupings is tracked over time.

10. The application of claim 1, wherein the valuator accesses anonymized data regarding values of NFTs owned by the owner.

11. The application of claim 10, wherein the value of NFTs owned by the owner are tracked in real-time.

12. The application of claim 10, wherein the value of NFTs owned by the owner are tracked over time.

13. The application of claim 1, wherein the value of the other NFTs not owned by the owner are tracked in real-time.

14. The application of claim 1, wherein the value of the other NFTs not owned by the owner are tracked over time.

15. The application of claim 1, wherein the valuator accesses anonymized data regarding supply or demand of the NFTs.

16. The application of claim 1, wherein the anonymized data regarding supply or demand of the NFTs comprises NFTs owned by the owner.

17. The application of claim 1, wherein the anonymized data regarding supply or demand of the NFTs comprises NFTs not owned by the owner.

18. The application of claim 1, wherein the valuator indexes supply or demand of the NFTs based on information in the NFTs.

19. The application of claim 1, further comprising an owner authenticator for accessing the application.

20. The application of 19, wherein the owner authenticator comprises a key selected from the group consisting of a biometric key, a pass key, and a multi-factor key.
